(19) United States
(12) Patent Application Publication
(10) Pub. No.: US 2003/0072519 A1
(43) Pub. Date: Apr. 17, 2003

(54) Photonic device, optical logic circuit incorporting the photonic device and method of manufacturing thereof

(76) Inventor: Miguel Holgado Bolanos, Madrid (ES)

Correspondence Address: HITT GAINES & BOISBRUN P.C., P.O. BOX 832570, RICHARDSON, TX, 75083, US

(21) Appl. No.: 09/981,412

(22) Filed: Oct. 17, 2001

(51) Int. Cl. G02B 6/35; G02B 6/26; H01S 3/00

(52) U.S. Cl. 385/16; 385/39; 359/333

(57) ABSTRACT

The present invention provides a photonic device, an optical logic circuit incorporating the photonic device and a method of manufacturing thereof. The photonic device may comprise a clathrated structure including a dielectric material, having a fluorescent material infiltrated therein. The photonic device may include a waveguide optically coupled to the clathrated structure.

### TECHNICAL FIELD OF THE INVENTION

The present invention is directed, in general, to optical devices and, more specifically, to a photonic device, a method of manufacture therefor, a method of operating the photonic device, and an optical logic circuit including the same.

### BACKGROUND OF THE INVENTION

Modern integrated circuits (ICs) generally contain millions of individual electronic devices, each typically the size of a few micrometers, interconnected on a substrate formed of semiconductor materials. To form the necessary complex patterns representing the devices and interconnections on such a substrate, complex microelectronic patterning is used. One of the more common processes used is photolithography, which uses an optical image and a photosensitive film to produce the patterns on the substrate. In addition, ICs may typically be made up of as many as fifty individual layers of silicon, polysilicon, silicon dioxide, metal and silicides, further increasing the complexity of the chips.

Arguably the most common electronic device found in ICs today is the transistor, perhaps because of its ability to perform both switching and current amplifying functions. Since its creation almost fifty years ago, arguably no single device has affected technology more. While starting as a large chuck of gallium arsenide, today's transistors have shrunk to almost unbelievably small dimensions. At present, gate thicknesses are reaching submicron measurements, resulting in switching speeds only imagined a few years ago. Although such amazingly small sizes allow millions of transistors to be placed on a single chip, packing density on today's IC chips seem to have reached a plateau. The most prominent problems seem to be associated with attempts to make transistors, and other semiconductor devices, even smaller in order to increase packing density and speed.

Among the problems associated with these submicron devices is parasitic capacitance across layers of the individual devices. As device layers become thinner, problems with parasitic capacitance become more prevalent. In addition, sheet resistance typically found throughout some or all of the multiple layers of devices forming an IC may affect conductivity within the chip. Even if these problems are addressed with state of the art measures, data loss typically associated with electrical data transmission is still likely to be a problem for chips incorporating this submicron technology. Given the ultimate structural and electrical limitations of this conventional transistor technology, it is apparent that there is a need and indeed will be a need for an improved technology.

A new technology currently being used includes using light as an input and output signal for the electronic transistors. In such a situation, input light is converted to an electrical signal prior to entering the transistor, the transistor switches the information as desired, and the switched information is then converted back to output light. Using light, as compared to an electrical signal, allows the IC to take advantage of many of the benefits associated with light, including efficient transportation of the signal, and efficient storage of information.

While certain benefits may be realized using the light as the input and output signal, certain drawbacks may also be experienced. For example, the optical to electrical and electrical to optical conversions may be inefficient, problematic, and unreliable, and therefore, they are not always desirable.

Accordingly, what is needed in the art is a device that may perform the functions of a semiconductor transistor and is capable of use in high packing density applications, that does not suffer from the deficiencies found in the prior art devices.

### SUMMARY OF THE INVENTION

To address the above-discussed deficiencies of the prior art, the present invention provides a photonic device, a method of manufacture therefor, a method of operating the photonic device, and an optical logic circuit including the same. The photonic device may include a clathrated structure that includes a dielectric material therein, having a fluorescent material infiltrated therein. The photonic device may further include a waveguide optically coupled to the clathrated structure.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following detailed description taken in conjunction with the accompanying FIGUREs. It is emphasized that various features may not be drawn to scale. In fact, the dimensions of various features may be arbitrarily increased or reduced for clarity of discussion. In addition, it is emphasized that some circuit components may not be illustrated for clarity of discussion. Reference is now made to the following descriptions taken in conjunction with the accompanying drawings, in which:

FIG. 1 illustrates one embodiment of a photonic device, according to the present invention, in a switching mode;

FIG. 2 illustrates one embodiment of a photonic device, according to the present invention, in an amplifying mode;

FIG. 3 illustrates a band structure in accordance with the principles of the present invention;

FIG. 4 illustrates a logic diagram of a direct photonic transistor of the present invention;

FIG. 5 illustrates a logic diagram of an inverted photonic transistor of the present invention;

FIG. 6 illustrates one embodiment of an optical logic circuit constructed using photonic devices according to the present invention; and

FIG. 7 illustrates one embodiment of an R-S flip flop in accordance with the principles of the present invention.

### DETAILED DESCRIPTION

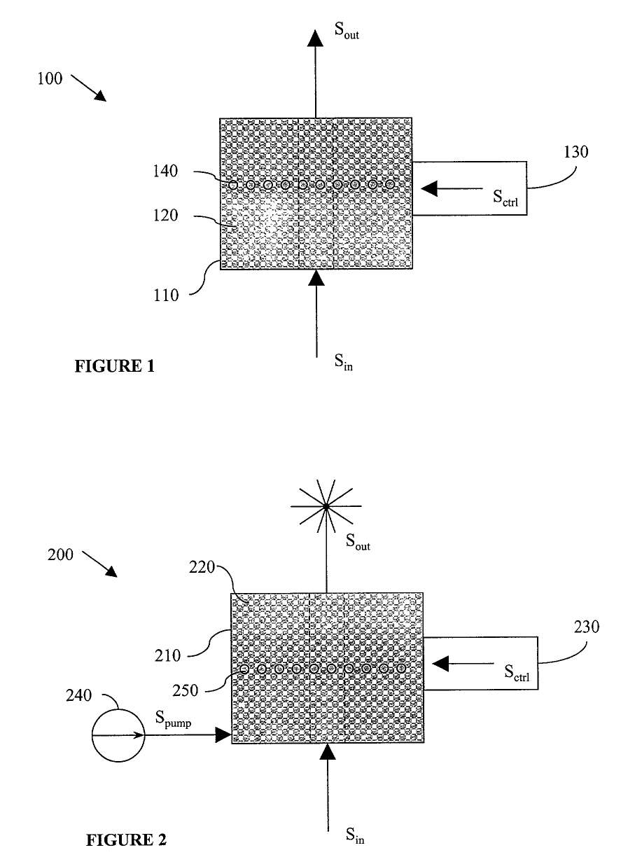

Referring initially to FIG. 1, illustrated is one embodiment of a photonic device, according to the present invention. In the exemplary embodiment of FIG. 1, the photonic device is a photonic transistor 100. As used herein, the term “photonic device” (e.g., the photonic transistor 100) means any optical device capable of manipulating and controlling, or otherwise performing a function on, a beam comprised of photons. For example, the photonic device may switch and amplify the beam of photons in a similar fashion as a conventional transistor would switch and amplify an electrical signal.

In many photonic structures (e.g., structures for use with photons), photons exhibit properties that are analogous to those of electrons in an electronic structure. Just as bandgaps may exist in an electronic structure that prevent the propagation of electrons, photonic bandgaps can similarly prevent the propagation of photons in a photonic structure. Photonic bandgaps may be created by layering materials of different dielectric constants within the photonic structure. Photons of a certain wavelength may scatter at the intersection of these layers, depending upon the dielectric constants of the materials and the dimensions of the layers.

Photonic bandgap structures are currently used in many applications, such as lasers, solar cells, and light waveguides. These structures may be one, two or three dimensional, based upon the number of axes along which scattering occurs or is desired, and are commonly known as photonic crystals. Photonic crystals generally have a periodic distribution of at least two materials, each with a different dielectric constant or index of refraction, in a lattice formation. A complete photonic bandgap may be created in a three dimensional photonic crystal, since a scattering occurs along all three axes. As is known in the art, three-dimensional photonic crystals may be manufactured using, for example, photolithography or inverse opals.

A photonic crystal having a complete bandgap (e.g., three dimensional) may be used to localize electromagnetic waves to specific areas, to inhibit or enhance stimulated emissions, and to guide propagation of electromagnetic waves along certain directions at restricted frequencies. All of these properties are important because they may be used, for instance, to improve the performance of semiconductor lasers, as well as other types of quantum electronic, optoelectronic and photonic devices. Especially important are photonic crystals having bandgaps in the neighborhood of 1.5 microns, the wavelength presently used for telecommunications transmissions across optical fibers. In an advantageous embodiment, the photonic crystal provides a photonic bandgap of about 1.5 microns, however other photonic bandgaps are also within the broad scope of the present invention.

Although photonic crystals have continued to gain popularity throughout the field of optical electronics, logic circuits incorporating such crystals have not been known. However, it has been presently recognized that such optical or photonic logic circuits as provided by the present invention will have distinct advantages over their current electronic counterparts. Accordingly, the present invention provides such photonic devices, for example, the photonic transistor 100 illustrated in FIG. 1.

In the illustrative embodiment shown in FIG. 1, the photonic transistor 100 comprises a clathrated structure that includes a dielectric material (hereafter referred to as a clathrated dielectric structure 110), having a fluorescent material 120 infiltrated therein. It should be noted that for illustration purposes only, the clathrated dielectric structure 110 is being depicted by the box and the fluorescent material 120 is being depicted by the various shaded circles within the box. It should further be noted that while the present invention refers to the clathrated dielectric structure 110 having a fluorescent material 120 infiltrated therein, that both the dielectric material and the fluorescent material may be infiltrated within a clathrated structure. For example, in one embodiment, a clathrated structure could be provided, a dielectric material could be included therein, and the fluorescent material could then be infiltrated within the clathrated structure having the dielectric material included therein.

While the clathrated dielectric structure 110 may comprise many materials and stay within the scope of the present invention, a clathrated dielectric structure 110 comprising a photonic crystal has been found to be particularly useful. In an alternative embodiment, however, a polymer material, a liquid crystal material, or another similar material may be used as the clathrated dielectric structure 110. Likewise, the fluorescent material 120 may comprise various materials. For example, in one illustrative embodiment, the fluorescent material 120 comprises a material selected from the group consisting of indium, gallium, arsenic, indium phosphide, arsenic gallenide and antimony sulfide. The fluorescent material 120 may further comprise neodymium doped Yttrium Aluminum Garnet (YAG) single crystal materials, ruby materials, laser materials, etc.

The photonic device 100 may be manufactured using a combination of various conventional processes. In one particular embodiment of the invention, the clathrated dielectric structure 110 is provided and the fluorescent material 120 is diffused therein. While one method has been briefly discussed herein, other processes for manufacturing the photonic device 100 are within the scope of the present invention. For example, certain other processes are more fully discussed in Photonic Bandgap Formation and Tunability in Certain Self-Organizing Systems, by Sajeev John and Kurt Busch, Journal of Lightwave Technology, Vol. 17, No. 11 (November 1999), which is incorporated herein by reference.

In the illustrative embodiment shown in FIG. 1, the photonic transistor 100 is being operated in a switching mode. As such, the photonic transistor 100 may further include a control waveguide 130 optically aligned with the clathrated dielectric structure 110. By optically aligning the control waveguide 130 with the clathrated dielectric structure 110, the control waveguide 130 may be used to introduce a control signal S_{ctrl} into the clathrated dielectric structure 110. In accordance with the principles of present invention, the control signal S_{ctrl} may be used to alter the photonic bandgap of the clathrated dielectric structure 110 (e.g., changing its optical transmission characteristics). By altering the photonic bandgap, an input signal Sᵢₙ having a given wavelength may pass through or be reflected by the clathrated dielectric structure 110.

As illustrated, the input signal Sᵢₙ is optically aligned with a lower side of the photonic transistor 100. Of course, in other embodiments, the input signal Sᵢₙ may be optically aligned with any surface of the photonic transistor 100. It should be noted that the same holds true for the control signal S_{ctrl}. If the photonic bandgap is adjusted to allow the input signal Sᵢₙ to pass through the clathrated dielectric structure 110, an output signal Sₒᵤₜ emerges from the photonic transistor 100.

In an exemplary embodiment of the present invention, the clathrated dielectric structure 110 includes a lattice defect 140. As used herein, the term “defect” means a specific nonuniform i periodic distribution in the lattice structure of a photonic crystal, among the otherwise substantially uniform periodic distribution therein. Those skilled in the art understand that by incorporating the defect 140 into the clathrated dielectric structure 110, the direction and wavelength of the output signal Sₒᵤₜ may be more accurately controlled. For example, in the present invention, the defect 140 causes the output signal Sₒᵤₜ to emerge from the upper most side of the photonic transistor 100. In addition, the use of the defect 140 in the clathrated dielectric structure 110 may provide a more pure wavelength in the output signal Sₒᵤₜ. Of course, a defect may be incorporated for these or other reasons, whether the photonic device of the present invention is operating in switching or amplifying mode.

The photonic transistor 100 in FIG. 1 may be used in a switching mode to reflect (e.g., block) the input signal Sᵢₙ, or allow it to pass through the clathrated dielectric structure 110. In such a switching mode, the photonic transistor 100 manipulates the passage of light in a way analogous to an electronic transistor's manipulation of the passage of electrons (e.g., electric current) therethrough. Additionally, an output of the photonic transistor 100 can be coupled with a 2-dimensional photonic crystal waveguide to interconnect and integrate various other photonic transistors.

As the input signal Sᵢₙ, which is typically a beam having a relatively broad range of wavelengths, is applied to clathrated dielectric structure 110, the fluorescent material 120 infiltrated within the clathrated dielectric structure 110 may fluoresce to convert, in effect, the broad range of wavelengths in the input signal Sᵢₙ to a specific range of wavelengths. More specifically, when the fluorescent material 120 fluoresces, the intensity of the input signal Sᵢₙ at its varying wavelengths may be concentrated at a single wavelength into the clathrated dielectric structure 110. After this conversion, since a beam having only a single wavelength (or a small range of wavelengths) is trying to pass through the clathrated dielectric structure 110, the control signal S_{ctrl} is used to easily reflect, or allow to pass through, the now-narrow wavelength of the input signal Sᵢₙ. Without converging the input signal Sᵢₙ to a single wavelength, or a specific range of wavelengths, as the photonic bandgap of the clathrated dielectric structure 110 is altered, some of the wavelength of the input signal Sᵢₙ might be reflected, while other wavelengths might simply pass through. In such a case, the photonic crystal 130 would likely not be capable of completely stopping the input signal Sᵢₙ when “switched off.”

In an exemplary embodiment where the clathrated dielectric structure 110 in FIG. 1 is formed from a polymer, or another material, the photonic bandgap of the clathrated dielectric structure 110 may be altered by applying a specific wavelength of light to it through the control signal S_{ctrl}. Those skilled in the art understand that various wavelengths applied to these materials might alter the dielectric constants of the materials found therein, and thus change the photonic bandgap of the clathrated dielectric structure 110. Alternatively, the clathrated dielectric structure 110 may comprise a liquid crystal material or other material. By applying the control signal S_{ctrl} with a given wavelength to the liquid crystal material, a resulting change in temperature may alter the dielectric constants of the liquid crystal materials.

Regardless of the material comprising the clathrated dielectric structure 110, when the photonic bandgap of the photonic transistor 100 is adjusted so as to allow the converged input signal Sᵢₙ to pass through, the signal Sᵢₙ may be allowed to exit the photonic transistor 100 as the output signal Sₒᵤₜ. In one embodiment, after the output signal Sₒᵤₜ exits the clathrated dielectric structure 110, it will have a specific spectral response of wavelengths defined by the crystal properties. In such an embodiment, the final output signal Sₒᵤₜ would emerge having approximately the same range of wavelength as the original input signal Sᵢₙ.

Turning now to FIG. 2, illustrated is one embodiment of a photonic device, according to the present invention, in an amplifying mode. In the illustrated embodiment, the photonic device is a photonic transistor 200 similar to the photonic transistor 100 of FIG. 1. The photonic transistor 200 includes a clathrated dielectric structure 210 having a fluorescent material 220 infiltrated therein. The clathrated dielectric structure 210 and fluorescent material 220 may comprise similar materials as the clathrated dielectric structure 110 and fluorescent material 120 depicted in FIG. 1, as well as be manufactured using similar processes. The photonic transistor 200 may further include a control waveguide 230 optically aligned with the clathrated dielectric structure 210, for providing a control signal S_{ctrl} to the clathrated dielectric structure 210. As before, the control signal S_{ctrl} may be used to alter the photonic bandgap of the clathrated dielectric structure 210 to allow, or prevent, the passage of an incoming signal based on its wavelength.

Operating in an amplifying mode, the photonic transistor 200 receives an input signal Sᵢₙ on a lower side of the clathrated dielectric structure 210 having the fluorescent material 220 infiltrated therein. In many cases, the input signal Sᵢₙ should be in tune with the spectral response of the fluorescent material 220. In the current example, before the clathrated dielectric structure 210 is adjusted to allow the input signal Sᵢₙ to pass therethrough, an amplification source, (or “pump”) 240 is optically aligned with the fluorescent material 220. The amplification source 240 is so optically aligned to provide an amplification signal Sₚᵤₘₚ to the fluorescent material 220. This is generally in the form of an stimulated emission of the particles within the fluorescent material 220. While it has been shown that the control signal S_{ctrl}, input signal Sᵢₙ, and amplification signal Sₚᵤₘₚ are provided using different waveguides, one skilled in the art understands that a single waveguide, such as a 2-dimensional photonic crystal, may be used to provide any one or all of the previously mentioned signals.

By providing the amplification signal Sₚᵤₘₚ to the fluorescent material 220 along with the input signal Sᵢₙ, the beam intensity (e.g., power) from the amplification signal Sₚᵤₘₚ is combined with the intensity of the input signal Sᵢₙ. More specifically, inputting the amplification signal Sₚᵤₘₚ causes an inversion of population (the atoms in a cubic wavelength switch from a passive medium or ground state to an active medium-e.g, change in its given optical transmission characteristic) in the fluorescent material 220. This inversion of population, in turn, results in a change in energy state of the photons, which results in an emission of photons and the intensity of the input signal Sᵢₙ being amplified.

Even with this increased intensity, the beam still might not be permitted to pass through the clathrated dielectric structure 210. In fact, advantageously, harmful spontaneous emissions emanating as a result of the amplified intensity also do not pass through the clathrated dielectric structure 210 until the photonic transistor 200 is “switched.” Only after the control signal S_{ctrl} is applied to the clathrated dielectric structure 210 to alter the photonic bandgap therein, is the beam allowed to pass through and provide an output signal Sₒᵤₜ. In one exemplary embodiment, however, the amplification signal Sₚᵤₘₚ may be used without using the control signal S_{ctrl}. In both cases, however, a defect 250 in the structure may ensure that the light propagation and its frequency is correct, as described above.

The embodiment in FIG. 2 differs from that of FIG. 1 in that the output signal Sₒᵤₜ in FIG. 2, while maintaining the same wavelength as the input signal Sᵢₙ, is now more powerful than the output signal emitted in FIG. 1. As a result, in such an amplifying mode, the photonic transistor 200 amplifies the passage of light in a way analogous to an electronic transistor's amplification of electrons (e.g., electrical current) passing therethrough. For example, the amplification of power between Sᵢₙ and Sₒᵤₜ is similar to the amplification of power in a bipolar transistor, however, in the present case the amplification energy comes from the pump light rather than an electrical source.

In one embodiment of the present invention, the photonic transistor 200 may receive a laser as the input signal Sᵢₙ. In such an embodiment, the stimulated emissions of radiation generated by the combination of the input signal Sᵢₙ and the amplification signal Sₚᵤₘₚ provide a powerful laser output signal Sₒᵤₜ. Those skilled in the art understand the numerous uses and advantages of optoelectronic lasers in today's competitive market. By creating a laser output using a photonic device according to the present invention, little or no loss occurs across the input signal as it travels through the photonic device and becomes amplified. Such loss often occurs in electronic transistors employed to create such a laser, a problem with which technicians have continuously struggled. Since the loss across the signal may be reduced, the photonic device of the present invention provides the possibility of a true zero-threshold laser.

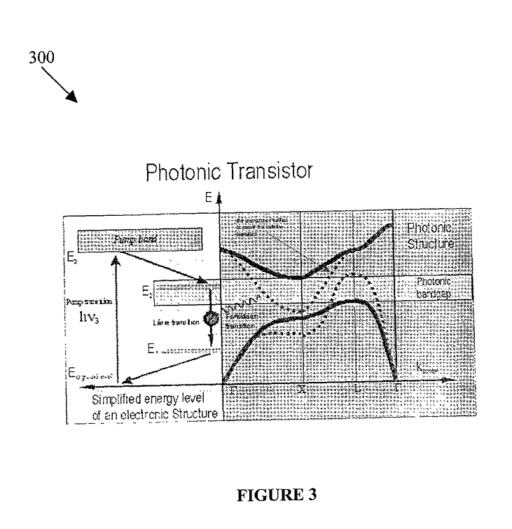

Turning briefly to FIG. 3, with continued reference to FIG. 2, illustrated is a band structure 300 depicting certain aspects of the amplification signal Sₚᵤₘₚ. FIG. 3 illustrates how certain optical properties may be controlled by using the photonic transistor 200, and tailoring its photonic bandgaps according to its electron properties. As illustrated, the spontaneous emission can be inhibited if its transition coincides with a photonic band gap.

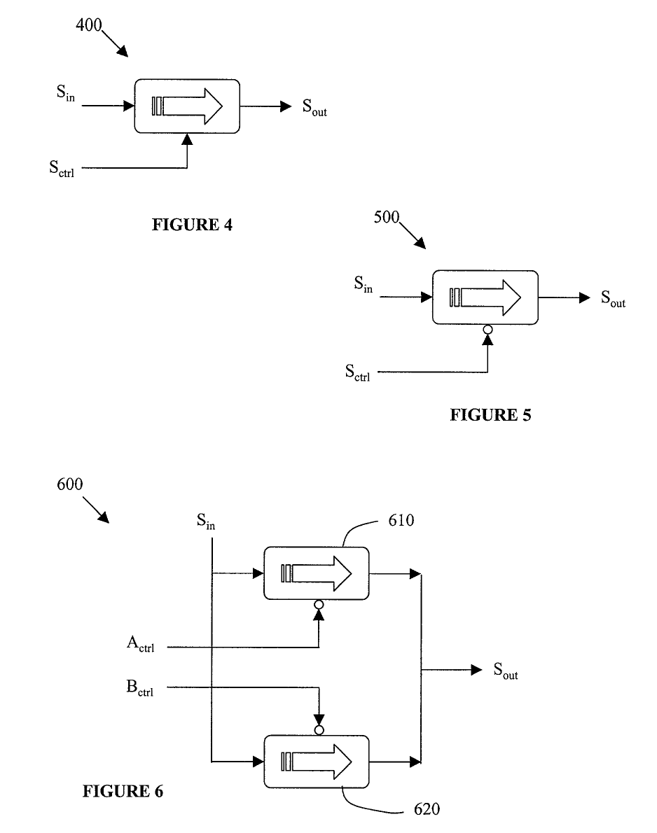

Looking now at FIG. 4, illustrated is a logic diagram of a direct photonic transistor 400 of the present invention. In this embodiment, the photonic transistor 400 is “direct” in that an input signal Sᵢₙ cannot pass through the photonic transistor 400 and create an output signal Sₒᵤₜ until a control signal S_{ctrl} is actively used to alter the photonic bandgap therein and allow passage. Stated another way, the photonic bandgap of the photonic transistor 400 is selected such that it reflects the wavelength of the input signal Sᵢₙ, until the control signal S_{ctrl} is employed to alter the photonic bandgap. As a result, a “direct” photonic device according to the present invention prevents passage of an input signal until a control signal is applied to alter the photonic bandgap therein and allow the input signal to pass through. A truth table of the logic possibilities of the direct photonic transistor 400 is shown in Table 1.

TABLE 1

| Input | Control | Output |
|---|---|---|
| Signal | Signal | Signal |
| 0 | 0 | 0 |
| 0 | 1 | 0 |
| 1 | 0 | 0 |
| 1 | 1 | 1 |

Referring now to FIG. 5, illustrated is a logic diagram of an inverted photonic transistor 500 of the present invention. In this embodiment, the photonic transistor 500 is “inverted” in its operation in that an input signal Sᵢₙ continues to pass through the photonic transistor 500 and create an output signal Sₒᵤₜ until a control signal S_{ctrl} is actively used to alter the photonic bandgap therein and reflect the input signal Sin. More specifically, the photonic bandage of the photonic transistor 500 is selected such that it permits the wavelength of the input signal Sᵢₙ to pass through until the control signal S_{ctrl} is employed to alter the photonic bandgap. As a result, an “inverted” photonic device according to the present invention continuously permits passage of an input signal until a control signal is applied to alter the photonic bandgap therein and reflect the input signal. A truth table of the logic possibilities of the inverted photonic transistor 500 is shown in Table 2.

TABLE 2

| Input | Control | Output |
|---|---|---|
| Signal | Signal | Signal |
| 0 | 0 | 0 |
| 0 | 1 | 0 |
| 1 | 0 | 1 |
| 1 | 1 | 0 |

Turning finally to FIG. 6, illustrated is one embodiment of an optical logic circuit 600 constructed using photonic devices according to the present invention. In the specific embodiment in FIG. 6, the optical logic circuit 600 is a NAND logic gate, however photonic devices according to the principles described herein, whether direct or inverted, may be employed to create any type of logic circuit. Examples of other optical logic circuits that may be constructed using photonic devices of the present invention include AND gates, OR gates, NOR gates, and R-S Flip-Flops, however this list of examples is not exhaustive.

The logic circuit 600 includes first and second photonic transistors 610, 620, which are inverted photonic transistors 610, 620. In accordance with the principles described herein, each of the photonic transistors 610, 620 includes a clathrated dielectric structure having a fluorescent material infiltrated therein. An input signal Sᵢₙ is input to each of the photonic transistors 610, 620.

First and second control waveguides (not separately designated) are optically coupled to the first and second photonic transistors 610, 620, respectively. The control waveguides provide first and second control signals A_{ctrl}, B_{ctrl}, respectively, to the first and second photonic transistors 610, 620. The outputs of the clathrated dielectric structures in each of the photonic transistors 610, 620 are optically coupled together using an optical interconnect system to provide a single output signal Sₒᵤₜ for use with other components or circuits (not illustrated). A truth table of the logic possibilities of the NAND logic gate illustrated in FIG. 6 is shown in Table 3.

TABLE 3

| Input | Control | Output |
|---|---|---|
| Signal | Signal | Signal |
| 0 | 0 | 1 |
| 0 | 1 | 1 |
| 1 | 0 | 1 |
| 1 | 1 | 0 |

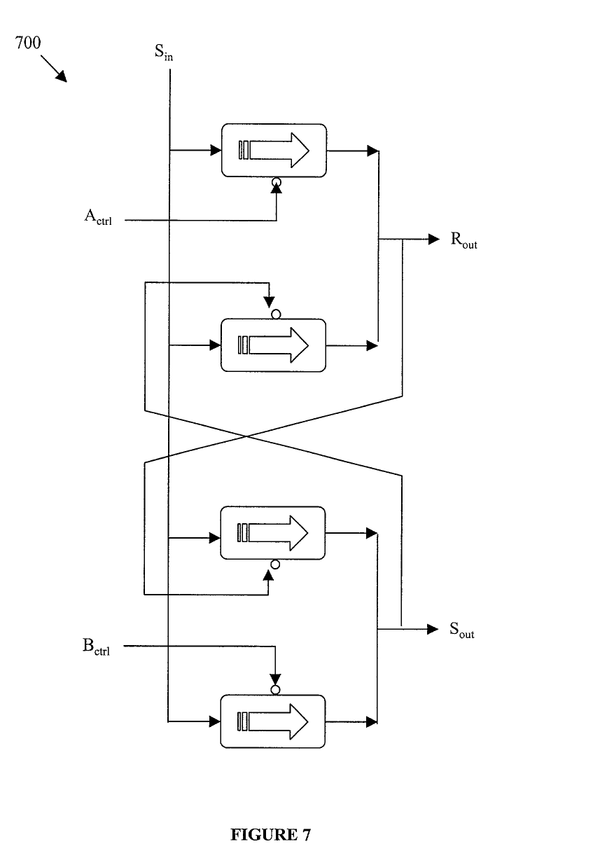

The ability to be able to produce a NAND gate having the photonic transistors, as illustrated in FIG. 6, is particularly beneficial. For example, if one has the ability to produce a NAND gate, one can produce the most complicated combinations of logic circuits available. For example, turning to FIG. 7, illustrated is a typical R-S flip flop 700 in accordance with the principles of the present invention. In the illustrative embodiment shown in FIG. 7, the R-S flip flop 700 includes 2 NAND gates, each of which may include a photonic transistor as described above.

By providing a photonic device that performs functions with optical beams analogous to the functions performed on electrons by electronic transistors, the present invention provides several benefits over the prior art. For instance, the present invention may eliminate the problems associated with sheet resistance along layers of devices in integrated circuit chips. In addition, the problems associated with parasitic capacitances that commonly plague the function and efficiency of electronic transistors in integrated circuits may also be eliminated. Those skilled in the art understand that by eliminating or even significantly reducing parasitic capacitances, IC devices may be manufactured smaller, thus increasing device packing density in IC chips. Of course, increasing packing density allows for more computing power in a smaller area, an important goal sought throughout the industry. In addition, smaller sizes may also lead to increased switching speeds in devices manufactured according to the present invention. Furthermore, by constructing an exclusively optical device, data loss typically associated with electronic data transmission is substantially reduced or eliminated. Moreover, a photonic device constructed according to the present invention is employable to create almost any type of optical logic circuit, while retaining benefits such as those described above.

Although the present invention has been described in detail, those skilled in the art should understand that they can make various changes, substitutions and alterations herein without departing from the spirit and scope of the invention in its broadest form.

What is claimed is:

1. A photonic device, comprising:
a clathrated structure including a dielectric material therein; and
a fluorescent material infiltrated within said clathrated structure.

2. The photonic device as recited in claim 1 wherein said clathrated structure including a dielectric material therein is a clathrated dielectric structure, and said fluorescent material is infiltrated within the clathrated dielectric structure.

3. The photonic device as recited in claim 1 wherein said clathrated structure is a photonic crystal.

4. The photonic device as recited in claim 1 wherein said fluorescent material comprises a material selected from the group consisting of indium, gallium, arsenic, indium phosphide, arsenic gallenide and antimony sulfide.

5. The photonic device as recited in claim 1 wherein said clathrated structure has a three-dimensional lattice structure.

6. The photonic device as recited in claim 1 further including an input source waveguide optically coupled to said clathrated structure.

7. The photonic device as recited in claim 1 further including a control source waveguide optically coupled to said clathrated structure for introducing a control signal into said clathrated structure.

8. The photonic device as recited in claim 1 further including an amplification source optically coupled to said fluorescent material for introducing an amplification signal into said fluorescent material.

9. The photonic device as recited in claim 1 wherein said clathrated structure includes a lattice defect.

10. An optical logic circuit, comprising:
photonic devices wherein each of said photonic devices includes a clathrated structure including a dielectric material and a fluorescent material infiltrated therein;
a waveguide optically coupled to at least one of said photonic devices for introducing an optical signal into said at least one of said photonic devices; and
an optical interconnect system coupling said photonic devices to form an operative optical logic circuit.

11. The optical logic circuit as recited in claim 10 wherein at least one of said clathrated structures comprises a photonic crystal.

12. The optical logic circuit as recited in claim 10 wherein said fluorescent material is selected from the group consisting of indium, gallium, arsenic, indium phosphide, arsenic gallenide and antimony sulfide.

13. The optical logic circuit as recited in claim 10 wherein said waveguide is an optical fiber selected from the group consisting of an input source fiber, a control source fiber or an amplification source fiber.

14. A method of manufacturing a photonic device, comprising:
providing a clathrated structure including a dielectric material therein;
infiltrating a fluorescent material within said clathrated structure; and
optically coupling an optical waveguide to said clathrated structure for introducing an optical signal into said clathrated structure.

15. The method as recited in claim 14 wherein providing a clathrated structure including a dielectric material therein includes providing a clathrated dielectric structure, and wherein infiltrating a fluorescent material within said clathrated structure includes infiltrating a fluorescent material within said clathrated dielectric structure.

16. The method as recited in claim 14 wherein providing a clathrated structure includes providing a photonic crystal comprising a polymer material or a liquid crystal material.

17. The method as recited in claim 14 wherein optically coupling an optical waveguide to said clathrated structure includes optically coupling a waveguide selected from the group consisting of an input source fiber, a control source fiber or an amplification source fiber to said clathrated structure.

18. A method of operating a photonic device, comprising:
transmitting a first optical signal to a clathrated structure including a dielectric material, and having a fluorescent material infiltrated therein, wherein said clathrated structure having said fluorescent material infiltrated therein has a given optical transmission characteristic; and
transmitting a second optical signal to said clathrated structure, wherein said second optical signal causes said given optical transmission characteristic to change.

19. The method as recited in claim 18 wherein said second optical signal is a control signal or an amplification signal and said given optical transmission characteristic is a bandgap or an inversion of population, respectively.

20. The method as recited in claim 19 wherein causing said bandgap to change includes causing said clathrated structure to switch on or off.

21. The method as recited in claim 18 wherein causing said inversion of population to change includes causing said fluorescent material to emit photons and amplify said first optical signal.
